(19) United States
(12) Patent Application Publication
(10) Pub. No.: US 2024/0132727 A1
(43) Pub. Date: Apr. 25, 2024

(54) MOLECULAR ASSEMBLY, USE OF THE MOLECULAR ASSEMBLY FOR PROVIDING ANTI-ADHESIVE SURFACES, AND METHOD FOR APPLYING THE MOLECULAR ASSEMBLY TO A SOLID SURFACE

(71) Applicant: LEIBNIZ-INSTITUT FÜR POLYMERFORSCHUNG DRESDEN E. V, 01069 Dresden (DE)

(72) Inventors: JENS FRIEDRICHS, Dresden (DE); RALF HELBIG, Dresden (DE); LARS DAVID RENNER, Dresden (DE); TILO POMPE, Dresden (DE); JENS-UWE SOMMER, Dresden (DE); CARSTEN WERNER, Dresden (DE)

(73) Assignee: LEIBNIZ-INSTITUT FÜR POLYMERFORSCHUNG DRESDEN E. V, 01069 Dresden (DE)

(21) Appl. No.: 18/279,007

(22) PCT Filed: Feb. 23, 2022
(86) PCT No.: PCT/DE2022/100147

§ 371 Date: Aug. 24, 2023

(30) Foreign Application Priority Data
Feb. 26, 2021 (DE) 10 2021 104 706.4
Feb. 23, 2022 (DE) 10 2022 104 237.5

(51) Int. Cl. C09D 4/00; B05D 1/00; C09D 5/00; C09D 7/20

(52) U.S. Cl. CPC C09D 4/00; B05D 1/005; C09D 5/00; C09D 7/20

(57) ABSTRACT

A molecular assembly having a structural formation of amphiphilic molecules is disclosed where the amphiphilic molecules are selected from a group containing amphiphilic molecules which a) have a hydrophobic moiety and a hydrophilic moiety b) are soluble in a polar aprotic solvent and form self-organizing layer structures in the absence of the polar aprotic solvent, and c) orient molecularly in formed layer structures at an interfacial layer, or in an aqueous environment. The amphiphilic molecules in the formed layer structure are in contact with an aqueous environment. A method for coating a solid surface with a molecular assembly is also disclosed, wherein the amphiphilic molecules are dissolved in a polar aprotic solvent, and resulting solution is applied to a solid surface by spin coating.

The invention relates to a molecular assembly of amphiphilic molecules having a structural formation and to the use of the molecular assembly for providing anti-adhesive surface coatings. The invention also relates to a method for coating a solid surface with the molecular assembly.

Various mechanisms for influencing the adhesion of surfaces are known from the plant and animal kingdoms. These include, for example, the lotus effect, which has already been transferred successfully to technical applications. While the molecular and structural properties defining interfacial phenomena in nature have been studied extensively, it has not been possible so far to explain fully the physical mechanisms underlying the control of the adhesion. The subject matter of current studies includes, for example, the anti-adhesive cuticle of Collembola, which has honeycomb-like structures with overhanging cross-sectional profiles. It was found that the lipid-rich envelope of the Collembola cuticle contains aliphatic hydrocarbons, in particular steroids, fatty acids and wax esters. While it can be assumed that wax esters promote the wetting-resistant properties of the cuticle, it was not possible to explain the role of components such as steroids and fatty acids. However, it is presumed that in particular physical properties of different molecules are responsible for adhesive and anti-adhesive effects.

The object of the invention consists in providing a possible way of utilising anti-adhesive properties, based on physical-chemical processes, of amphiphilic molecules.

The object is achieved by a molecular assembly having the features according to claim 1 and a method according to claim 11. Developments are specified in the dependent claims.

The essence of the invention is a molecular assembly of selected amphiphilic molecules which are structured in layers and are subject to spontaneous reorientation processes and thus form an entropic barrier to adhesion when in contact with an aqueous environment.

Proposed is a molecular assembly having a structural formation of amphiphilic molecules, characterised in that the amphiphilic molecules are selected from a group containing amphiphilic molecules which
a) have a hydrophobic moiety, which is larger than a hydrophilic moiety in relation to the molecular weight,
b) are soluble in a polar aprotic solvent and form self-organising layer structures out of the solution in the absence of the polar aprotic solvent, and
c) orient molecularly in formed layer structures, in particular in an interfacial layer, depending on the polarity of the environment, which is preferably an aqueous environment,
wherein the amphiphilic molecules in the formed structure are in contact with an aqueous environment.

The interfacial layer is understood to mean a layer of the layer structure of the molecular assembly which is in contact with the aqueous environment. The surface of the interfacial layer forms an interface.

Within the meaning of the invention, contact with an aqueous environment means complete wetting of one side of the formed structure of the molecular assembly according to the invention with water. The wetted side forms an interface.

For the molecular assembly according to the invention, amphiphilic molecules having the features according to a), b) and c) are considered.

The molecular assembly according to the invention is based on the ability of the selected amphiphilic molecules to form layer structures by self-organisation. Accordingly, the molecular assembly is preferably a layer structure of amphiphilic molecules, wherein the amphiphilic molecules are oriented perpendicularly to an interface. This layer structure consisting of one or more layers can also be referred to as an assemblage.

It was found that the formation of molecular assemblies of the selected amphiphilic molecules in the structures of molecular layers or molecular interfacial layers brings about an amphiphilia-induced, spontaneous reorientation process of the amphiphilic molecules in the molecular interfacial layer of corresponding interfacial layer structures on contact with an aqueous environment, which results in an anti-adhesive effect on proteins and micro-organisms, in particular bacteria, present in the aqueous environment.

The spontaneous reorientation processes of individual molecules causing the anti-adhesive properties of the molecular assembly are based on the tendency of individual amphiphilic molecules to autogenic orientation.

The selection of the amphiphilic molecules can preferably comprise amphiphilic molecules in which the hydrophobic moiety accounts for at least 95%, preferably more than 95% of the molecular weight of the amphiphilic molecules. This applies in particular to cholesterol molecules.

The desired effect of the spontaneous reorientation processes within the molecular assembly has also been found in amphiphilic molecules of the type in question which have a molecular weight in the range of 300 g/mol to 2000 g/mol, preferably in the range of 300 g/mol to 413 g/mol. Preferably, the molecular assembly according to the invention can have amphiphilic molecules with a molecular weight in the range of 300 g/mol bis 413 g/mol. Molecular assemblies having amphiphilic molecules of the type in question with a molecular weight greater than 2000 g/mol are conceivable. Therefore, in particular synthetically produced amphiphilic molecules can have a higher molecular weight, that is, a molecular weight greater than 2000 g/mol and meet the requirements of a), b) and c).

The molecular assembly according to the invention can also have amphiphilic molecules, the molecular orientation of which within formed interfacial layers of the layer structure is based on the polarity of the environment such that a change in the polarity of the environment causes a change in the molecular orientation of the interfacial layer of the formed layer structure.

According to one embodiment of the molecular assembly according to the invention, the amphiphilic molecules can be polycyclic alcohols, in particular sterols.

It can also be provided for the molecular assembly to have a mass percentage of at least 1 weight % (abbreviated to wt % below), preferably at least 10 wt % cholesterol molecules and/or dehydrocholesterol molecules. That is, at least 1 wt %, preferably at least 10 wt % of the selected amphiphilic molecules can be cholesterol molecules and/or dehydrocholesterol molecules. The proportion of cholesterol molecules and/or dehydrocholesterol molecules has a positive influence on the anti-adhesive effect of the molecular assembly in the form of an interfacial layer structure on contact with an aqueous environment.

According to a further embodiment of the molecular assembly according to the invention, it can be provided for the amphiphilic molecules to be stigmasterol, cholecalciferol and/or retinol. It was found that stigmasterol molecules, cholecalciferol molecules and retinol molecules in the molecular assembly reorient comparatively rapidly on contact with an aqueous environment and have hardly any spontaneous reorientation processes, which is associated with a worsening of the anti-adhesive properties of the molecular assembly. However, the anti-adhesive effect is significantly better than for molecular assemblies of similar, non-amphiphilic molecules. If stigmasterol molecules, cholecalciferol molecules and retinol molecules are used, it is therefore advantageous if additionally at least 1 wt %, preferably at least 10 wt % cholesterol molecules and/or dehydrocholesterol molecules are used to provide the molecular assembly.

Furthermore, cholesterol molecules, dehydrocholesterol molecules, stigmasterol molecules, cholecalciferol molecules and retinol molecules can be used as amphiphilic molecules to form the molecular assembly. Different ratios of cholesterol molecules, dehydrocholesterol molecules, stigmasterol molecules, cholecalciferol molecules and retinol molecules can be used.

It is assumed that cholesterol molecules form triclinic crystals, which results in a comparatively “loose” arrangement in corresponding layers of the molecular assembly. This favours the mobility of the molecules in the layer. In contrast to this, stearic and palmitic acid molecules, which are constituents of the Collembola cuticle, form monoclinic crystals and accumulate in tightly packed layers, as a result of which possible amphiphilia-induced spontaneous reorientation processes of the molecules are prevented when the polarity of the surrounding medium changes.

The molecular assembly according to the invention has the following further properties:

A change in the polarity of the surrounding/contacting medium leads to an amphiphilia-induced reorientation of the amphiphilic molecules in the molecular interfacial layer of corresponding assemblages (layer structures). This reorientation can be detected macroscopically by means of dynamic contact angle measurements or microscopically by means of atomic force microscopy-based force spectroscopy. The spontaneous reorientation processes of amphiphilic molecules in the molecular interfacial layer of corresponding assemblages of the molecular assembly form, on contact with aqueous solutions, the basis for entropy-induced anti-adhesive properties, which can be detected by means of spatially resolved and time-resolved atomic force microscopy-based force spectroscopy.

The molecular assembly according to the invention can be designed structurally in the form of multilayers of cholesterol molecules. Such cholesterol multilayers exhibit very characteristic behaviour during dynamic contact angle measurement. In dynamic contact angle measurement, a water droplet is applied to the molecular assembly under examination and the shape of the droplet is observed. The droplet is then sucked up again and the droplet shape is again observed in the process. This procedure is repeated with different application times. With molecular assemblies in the structure of cholesterol multilayers, the shape of the droplet on application indicates a moderately hydrophobic interface. If the droplet is sucked up again immediately after application, its shape remains unchanged, which again indicates hydrophobic properties of the interface of the molecular assembly. With a longer application time of 20 seconds, for example, a different picture emerges. The droplet collapses, which indicates a very hydrophilic interface of the molecular assembly. Similar behaviour was observed for molecular assemblies of cholesterol analogues.

The molecular assembly according to the invention can therefore have a mixture of different proportions of amphiphilic molecules, in particular cholesterol analogues having the properties a), b) and c). Preferably, the molecular assembly according to the invention has at least 1 wt % cholesterol molecules. The molecular assembly according to the invention can also have non-amphiphilic molecules which are suitable for integrating within the structure of the molecular assembly. The proportion of non-amphiphilic molecules of the molecular assembly can have a mass percentage of up to 99 wt %. The non-amphiphilic molecules used can be stearyl palmitate molecules, for example. According to one embodiment of the molecular assembly according to the invention, stearyl palmitate molecules can be present in a proportion of 99 wt %. In this case, cholesterol molecules are preferably used as the amphiphilic molecules.

The layer structures of the molecular assembly according to the invention can have a thickness of 15 nm.

Preferably, the molecular assembly is deposited in the form of a layer structure of cholesterol molecules arranged perpendicularly to an interface on a solid surface by means of spin coating. In the process, the interface of the layer structure facing away from the solid surface is in contact with an aqueous solution, preferably pure water.

The molecular assembly according to the invention serves in particular for use as anti-adhesive agents for solid surfaces.

The subject matter of the invention is also a method for coating a solid surface with the molecular assembly according to the invention, wherein the amphiphilic molecules are first dissolved in a polar aprotic solvent, and the solution thus produced is then applied to a solid surface by means of spin coating. The amphiphilic molecules are applied to the solid surface by the spin coating. As a result of the application and subsequent removal of the polar aprotic solvent, the amphiphilic molecules assemble to form layer structures, which, after removal of the polar aprotic solvent, can be brought into contact with an aqueous environment in order to form the anti-adhesive properties.

Chloroform can be used as the polar aprotic solvent. The solvent evaporates after application to the solid surface. An air stream or a vacuum can be used to assist the evaporation of the solvent.

Conceivable further solvents are acetone, benzene, ethanol, ether, hexane or methanol.

Further details, features and advantages of embodiments of the invention can be found in the description of exemplary embodiments below with reference to the associated drawings. In the drawings:

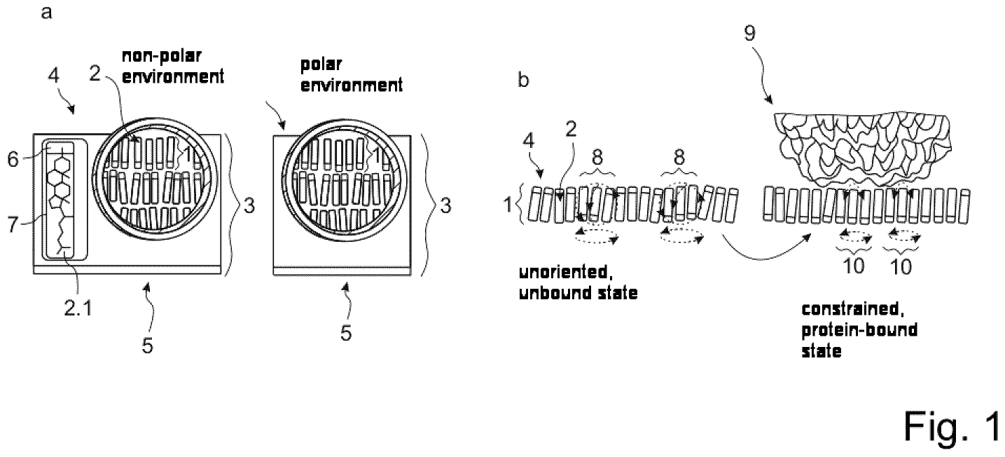

FIG. 1: shows a highly simplified schematic diagram of the molecular assembly according to the invention to explain the anti-adhesive property of the molecular assembly,

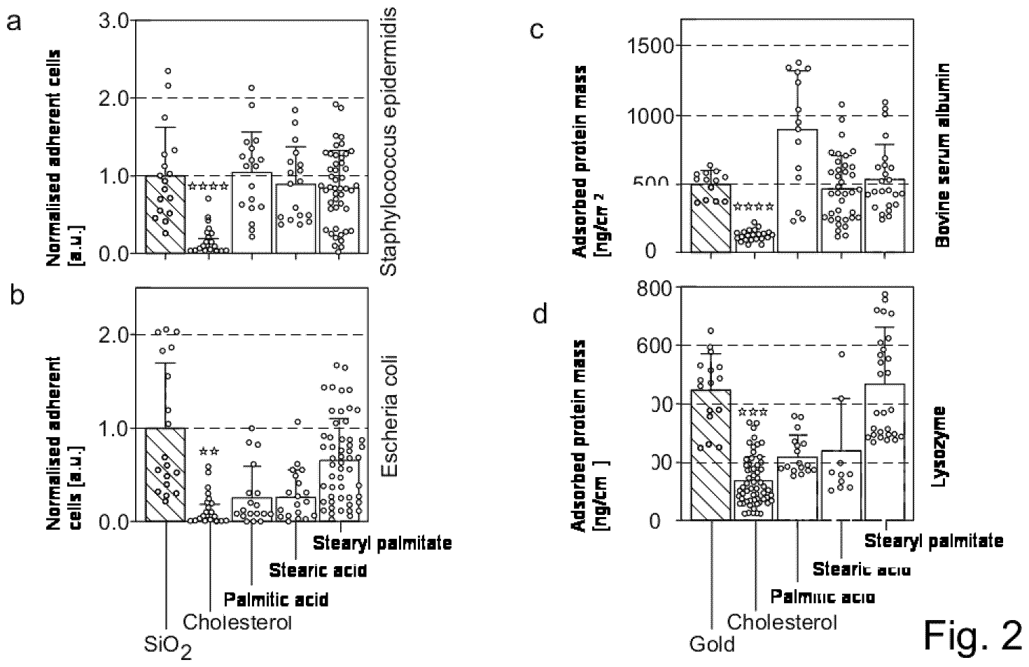

FIG. 2: shows the results of measurements of bacterial adhesion (a and b) and protein adsorption (c and d) to molecular assemblies, and

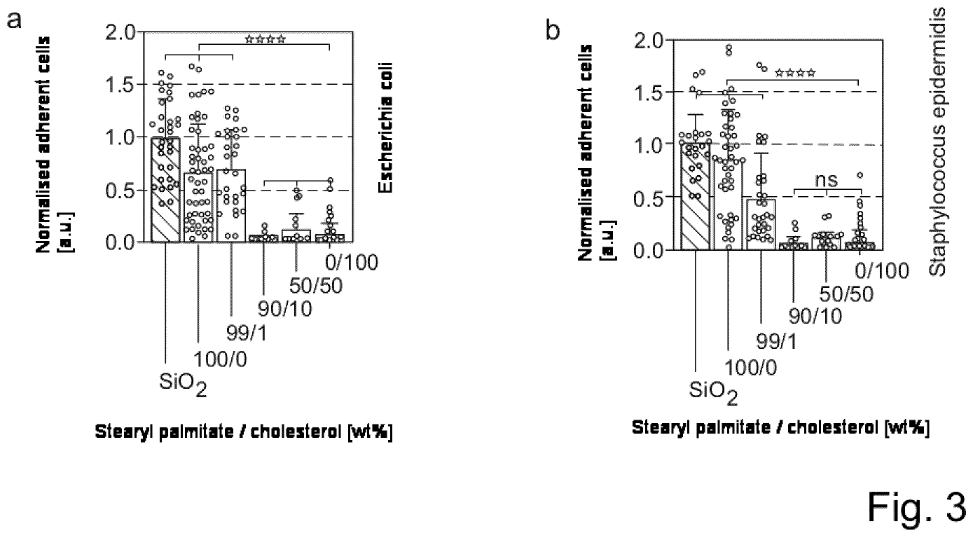

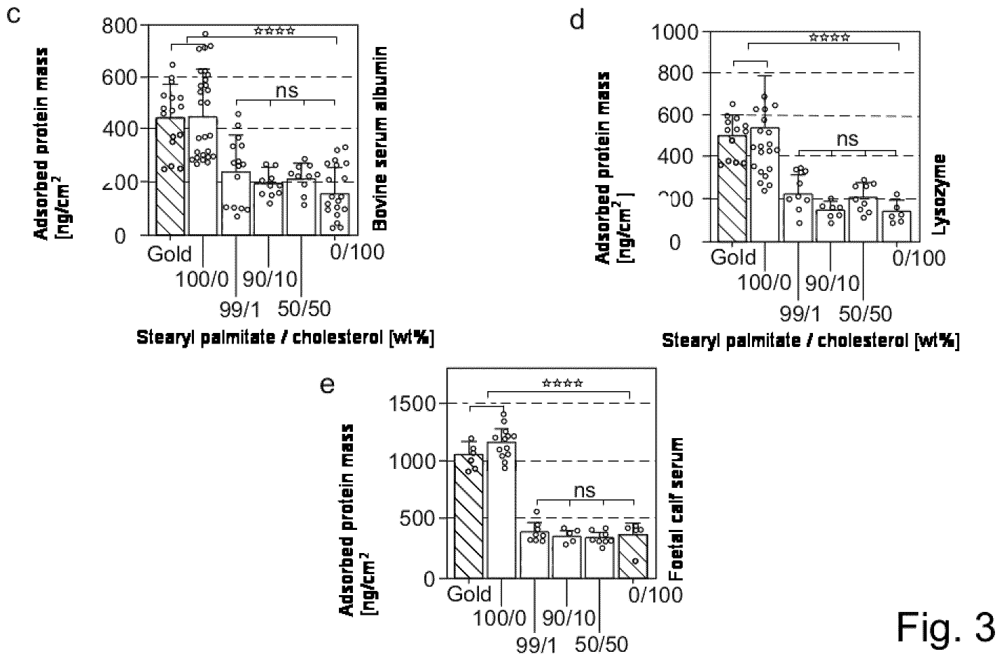

FIG. 3: shows results of measurements of bacterial adhesion (a and b) and protein adsorption (c, d and e) to molecular assemblies formed from stearyl palmitate or cholesterol molecules or to molecular assemblies formed from stearyl palmitate and cholesterol molecules, in different mixing ratios.

The invention is based on the finding that the combination of selected amphiphilic molecules, in particular cholesterol molecules, and the effective self-organisation of the selected molecules in molecular assemblies in the form of multilayer structures, which produces a slow, adaptive, cooperative interface mobility of the molecular assembly, results in a pronounced entropic repulsion of proteins and micro-organisms.

FIG. 1a shows a highly simplified schematic diagram of the molecular assembly 1 according to the invention using the example of cholesterol molecules 2 as the selected amphiphilic molecules. FIG. 1a shows layer structures 3 of the molecular assembly 1, which is applied to a solid surface 5 with the cholesterol molecules 2 oriented perpendicularly to an interface 4. Reference sign 2.1 denotes a single cholesterol molecule of the molecular assembly 1, shown enlarged. The cholesterol molecule 2.1 has a polar moiety 6 and a non-polar moiety 7. The cholesterol molecules 2 arranged at the interface 4 within the layer structure 3 of the molecular assembly 1 and therefore located in an interfacial layer of the layer structure 3 orient themselves depending on the polarity of the surrounding medium. In a non-polar environment, for example air, the non-polar moiety 7 points towards the interface 4, while in a polar surrounding medium, for example water, the polar moiety 6 is initially oriented towards the interface 4. Within the layer structure 3 of the molecular assembly 1, the cholesterol molecules 2 tend to spontaneous reorientation processes on contact with an aqueous solution, which is shown in FIG. 1b.

FIG. 1b shows the molecular assembly 1 wherein the interface 4 is in contact with a polar environment. The cholesterol molecules 2 are initially oriented with their polar moiety 6 towards the interface 4. However, spontaneous reorientation processes (i.e. the non-polar moiety 7 temporarily points in the direction of the interface 4) of individual cholesterol molecules 2 or of small collections 8 of cholesterol molecules 2 are found. These spontaneous reorientation processes are shown by way of example for two molecules/molecule collections with dashed lines in FIG. 1b. The direction of the possible reorientation of the cholesterol molecules 2 within the layer structure 3 is indicated in each case with arrow heads.

Furthermore, FIG. 1b shows the transition of cholesterol molecules 2 at the interface 4 from the unoriented, unbound state to the constrained, protein-bound state. Bonding of a protein 9 at the interface 4 constrains cholesterol molecules 2 in their spontaneous reorientation processes. This constraint is shown with the reference sign 10. Owing to the entropy-induced tendency of the molecules to regain their reorientation ability, the bonding of the protein 9 at the interface 4 is weakened due to the minimisation of the free enthalpy, and therefore the protein 9 becomes detached.

The method for coating a solid surface 5 with the molecular assembly 1 is explained in more detail below.

The molecular assembly 1 can be applied to a solid surface 5 by spin coating, wherein layer structures 3 of the molecular assembly 1 are formed. Such layer structures 3 of selected amphiphilic molecules are referred to below as SCLs (spin-coated lipid multilayers).

SCLs are produced on silicon wafers as the substrate. The substrates, which can have a size of 10×15 mm², are cleaned by immersion in a solution of deionised water, ammonia and hydrogen peroxide (volume ratio 5/1/1) for 15 min at 70° C., repeatedly rinsed in Milli-Q water and then dried in a nitrogen stream. The cleaned substrates are immediately used for producing SCLs by spin coating. For the spin coating, cholesterol molecules 2 are dissolved in chloroform (concentration 2 wt %). The solution thus produced is applied to the solid surface 5 by spin coating (LabSpin6, SÜSS MicroTec) at a rotation speed of 3000 revolutions per minute and an acceleration of 3000 revolutions per minute/second for 30 seconds. The anti-adhesive properties form as soon as the formed layer structures 3 are brought into contact with an aqueous solution.

FIG. 2 shows the results of measurements of bacterial adhesion (a and b) and protein adsorption (c and d) to molecular assemblies consisting of molecules which were identified in the lipid-rich envelope of Collembola. Two different bacterial species (Staphylococcus epidermidis [a] and Escherichia coli [b]) and two different protein types (bovine serum albumin [c] and lysozyme [d]) were used for the experiments. Images a and b plot the normalised count (normalised relative to the control surface—silicon dioxide [SiO2]) of the bacteria which were found on the respective surfaces after one hour of incubation time. Images c and d plot the absolute adsorbed protein mass (determined by measurements with an oscillating quartz microbalance) on the respective surfaces. In the measurement of bacterial adhesion (a and b) and in the measurement of protein adsorption (c and d), the smallest amounts of bacteria and proteins were always detected on molecular assemblies formed from cholesterol molecules. The observed differences were statistically significant.

FIG. 3 shows results of measurements of bacterial adhesion (a and b) and protein adsorption (c, d and e) to molecular assemblies formed from stearyl palmitate or cholesterol molecules, or to molecular assemblies formed from stearyl palmitate and cholesterol molecules, in different mixing ratios (100/0=100 wt % stearyl palmitate+0 wt % cholesterol; 99/1=99 wt % stearyl palmitate+1 wt % cholesterol; 90/10=90 wt % stearyl palmitate+10 wt % cholesterol; 50/50=50 wt % stearyl palmitate+50 wt % cholesterol; 0/100=0 wt % stearyl palmitate+100 wt % cholesterol). In the experiments carried out, it was investigated whether the adhesion-reducing properties of molecular assemblies of cholesterol molecules are retained when mixed molecular assemblies are produced from cholesterol molecules and a second component (stearyl palmitate) which does not have adhesion-reducing properties. Two different bacterial species (Staphylococcus epidermidis [a] and Escherichia coli [b]), two different protein types (bovine serum albumin [c] and lysozyme [d]), and a complex protein mixture (10% foetal calf serum [e]) were used for the experiments. Images a and b of FIG. 3 plot the normalised count (normalised relative to the control surface—silicon dioxide [SiO2]) of the bacteria which were found on the respective surfaces after one hour of incubation time. Images c, d and e plot the absolute adsorbed protein mass (determined by measurements with an oscillating quartz microbalance) on the respective surfaces. In the measurements for bacterial adhesion (images a and b), it was found that even a weight percentage of 10% cholesterol molecules in mixed molecular assemblies leads to a reduction in bacterial adhesion comparable to molecular assemblies with 100 wt % cholesterol molecules. On the other hand, in the measurements for protein adsorption (images c, d and e), it was found that even a weight percentage of 1% cholesterol molecules in mixed molecular assemblies leads to a reduction in bacterial adhesion comparable to molecular assemblies consisting of 100 wt % cholesterol molecules.

Cholesterol SCLs Adapt Dynamically to the Polarity of their Environment

The reorientation ability of the cholesterol molecules 2 within molecular assemblies 1 of layer structures 3, depending on the polarity of the surrounding medium, was detected by means of dynamic contact angle measurements and atomic force microscopy-based force spectroscopy.

Force-spectroscopic measurements were carried out with hydrophobic colloidal probes or individual Escherichia coli cells immobilised on the tip of the colloidal probes. Both types of probe were pressed for different time intervals onto the surface of cholesterol SCLs, which were immersed in aqueous solutions. The resulting interaction forces were quantified and it was found that they increase continuously with contact time, which proves the reorientation of the cholesterol molecules with the non-polar moiety of the molecule in the direction of the interface (to maximise the hydrophobic interactions). When contact was interrupted, the initial state of the interface was restored in contact with water, i.e., the reorientation process was repeatable multiple times.

Dynamic contact angle measurements on cholesterol SCLs in air produced similarly high advancing and receding water contact angles when the droplet was removed again immediately after application. These results indicate that the non-polar moiety of the cholesterol molecules at the interfacial layer is initially oriented towards the interface, while the polar moiety is directed inwards. However, if the droplet is kept on the surface for approximately 20 seconds after application, before it is removed, strong pinning of the three-phase contact line was observed, which indicates an interface with hydrophilic properties. Within the 20-second waiting time, a reorientation of the cholesterol molecules therefore occurred, which now point with the polar moiety in the direction of the interface. This process was also reversible.

### Reorientation Fluctuations at the Interface of Cholesterol-Containing SCLs are Responsible for the Entropic Repulsion

It was demonstrated that the anti-adhesive properties of cholesterol-containing SCLs correlate with their dynamic adaptation as a reaction to changes in the polarity of the environment. It can be assumed that entropically driven orientation fluctuations of cholesterol molecules at the interface link these features mechanistically. Any adsorption of biomolecules or accumulation of (bacterial) cells requires an adaptation of the orientation (polarity) of the SCL interface, which constrains the orientation states of cholesterol and thereby reduces the entropy of the system. It was observed that protein adsorption to cholesterol SCLs decreased when the temperature was raised from 15° C. to 40° C.

The discovered entropic bioadhesion barrier which results from reorientation processes at the interface of cholesterol-containing SCLs allows numerous technical applications.

The results show that cholesterol organises itself in molecular assemblies which can limit bioadhesion via entropic effects. The combination of the amphiphilia of the cholesterol molecules and their effective assembly in layer structures, which produces a slowly adaptive, cooperative interface mobility of the assemblies, was identified as a precondition for a pronounced entropic repulsion.

### LIST OF REFERENCE NUMERALS

1 Molecular assembly
2 Cholesterol molecules
2.1 Cholesterol molecule
3 Layer structure
4 Interface
5 Solid surface
6 Polar moiety
7 Non-polar moiety
8 Molecule collections
9 Protein
10 Constraint of reorientation

1. A molecular assembly comprising a structural formation of amphiphilic molecules, wherein the amphiphilic molecules are selected from a group containing amphiphilic molecules which a) have a hydrophobic moiety, which is larger than a hydrophilic moiety in relation to the molecular weight, b) are soluble in a polar aprotic solvent and form self-organizing layer structures out of the solution in the absence of the polar aprotic solvent, and c) orient molecularly in formed layer structures, by way of an interfacial layer, in an aqueous environment, wherein the amphiphilic molecules in the formed layer structure are in contact with an aqueous environment.

2. The molecular assembly according to claim 1, wherein the hydrophobic moiety accounts for at least 95%, or more than 95% of the molecular weight of the amphiphilic molecules.

3. The molecular assembly according to claim 2, wherein the amphiphilic molecules have a molecular weight in the range of 300 g/mol to 2000 g/mol.

4. The molecular assembly according to claim 1, wherein the amphiphilic molecules are used, the molecular orientation of which within formed interfacial layers of the layer structure (3) is based on the polarity of the environment such that a change in the polarity of the environment causes a change in the molecular orientation of the interfacial layer of the layer structure (3).

5. The molecular assembly according claim 4, wherein the amphiphilic molecules are polycyclic alcohols, in particular sterols.

6. The molecular assembly according to claim 1, wherein at least 1 wt % of the amphiphilic molecules are cholesterol molecules and/or dehydrocholesterol molecules.

7. The molecular assembly according to claim 4, wherein the amphiphilic molecules are stigmasterol, cholecalciferol and/or retinol.

8. The molecular assembly according to claim 7 wherein cholesterol molecules, dehydrocholesterol molecules, stigmasterol molecules, cholecalciferol molecules or retinol molecules are used as amphiphilic molecules.

9. The molecular assembly according to claim 1 further comprising a proportion of up to 99 wt % non-amphiphilic molecules, in particular stearyl palmitate molecules.

10. A method of using the molecular assembly according to claim 1, by applying the resulting component as an anti-adhesive agent for solid surfaces.

11. A method for coating a solid surface with a molecular assembly in layer structures according to claim 1, wherein the amphiphilic molecules are dissolved in a polar aprotic solvent, and the solution thus produced is applied to a solid surface by spin coating.

12. The method according to claim 11, wherein chloroform is used as the polar aprotic solvent.

13. The molecular assembly according to claim 3, wherein the amphiphilic molecules weight have a molecular weight in the range of 300 g/mol to 413 g/mol.

14. The molecular assembly according to claim 1, wherein at least 10 wt % of the amphiphilic molecules are cholesterol molecules and/or dehydrocholesterol molecules.
